(19) United States
(12) Patent Application Publication
(10) Pub. No.: US 2014/0017434 A1
(43) Pub. Date: Jan. 16, 2014

(54) INJECTION-MOLDED PRODUCT AND MOLD FOR FABRICATING THE SAME

(71) Applicant: SAMSUNG ELECTRONICS CO., LTD., Suwon-si (KR)

(72) Inventors: Sang-Hyeon KIM, Gumi-si (KR); Su-Kyu LEE, Suyeong-gu (KR)

(73) Assignee: Samsung Electronics Co., Ltd., Suwon-si (KR)

(21) Appl. No.: 13/853,576

(22) Filed: Mar. 29, 2013

(30) Foreign Application Priority Data
Jul. 13, 2012 (KR) 10-2012-0076560

(51) Int. Cl. B32B 3/26

(52) U.S. Cl. CPC B32B 3/266
USPC 428/68; 425/129.1

(57) ABSTRACT

An injection-molded product includes a reinforcement member formed with a through-hole, a heat-resistant member attached to an outer surface of the reinforcement member to close an opening of the through-hole, and an injection-molded member comprising a synthetic resin that encloses the outer surface of the reinforcement member. The injection-molded product allows the thickness of a portable electronic device to be reduced by about 0.4 mm as compared to injection-molded product of the related art when it is used as a case of the portable electronic device while securing a structural strength and impact resistance in the same level as those of the conventional injection-molded product. Because the infiltration of a molten resin into the through-hole of the reinforcement member is prevented by arranging the heat-resistant member to close the through-hole, it is possible to prevent a poor molding, such as contraction on the outer appearance of the injection-molded product.

### PRIORITY

This application claims the benefit under 35 U.S.C. §119(a) of a Korean patent application filed on Jul. 13, 2012 in the Korean Intellectual Property Office and assigned Serial No. 10-2012-0076560, the entire disclosure of which is hereby incorporated by reference.

### BACKGROUND OF THE INVENTION

1. Field of the Invention

The present invention relates to an injection-molded product. More particularly, the present invention relates to a dual injection-molded product which may be used as a case for a portable electronic device, such as a portable terminal.

2. Description of the Related Art

In general, injection molding is a method of molding a synthetic resin into a desired shape by first fabricating a mold having a cavity with a shape corresponding to that of a desired injection-molded product, injecting a molten synthetic resin into the cavity in the mold, and then cooling the synthetic resin in the cavity to be solidified and molded to the desired shape. Injection molding is widely used for fabricating various products including those having a simple shape, such as a kitchen container, to those having a complicated shape, such as a case for an electronic device such as a wired home telephone, an MP3 player, a mobile phone, or an electronic scheduler. The reason why injection molding is widely used in spite of the high cost in fabricating a mold is because injection molding is advantageous in mass-producing products with consistent quality after only a single mold is fabricated.

With the development of super-high speed wired/wireless Internet and mobile telecommunication services, the use of portable electronic devices, such as mobile phones, electronic schedulers, MP3 players, and portable multimedia reproducing devices, is popularized. This in turn increases the number of products that are manufactured using injection molding. In their initial stages, mobile communication services were limited to voice communication or short message transmission. However, various advanced functions, such as a multimedia service, a banking/security service, and an Internet access, have been gradually integrated into a single mobile communication terminal Accordingly, various efforts to miniaturize and slim down a portable terminal while providing a large screen suitable for the multimedia functions or the like are continuously made by expanding the display device of such a portable terminal and incorporating a touch screen function to the display device to replace a physical keypad.

In order to miniaturize and slim down a portable terminal, it is required to reduce the thickness of a case of the portable terminal. At the same time, the strength of the case itself should be ensured in order to secure a structural strength and impact resistance. A dual injection molding process may be used in order to secure the strength of the case itself while reducing the thickness of the case. The dual injection molding process injection-molds a case in a state where a metallic reinforcement member is inserted into the mold.

FIG. 1 is a top plan view illustrating a reinforcement member used for molding a case for a portable terminal according to the related art. FIG. 2 is a perspective view illustrating an injection-molded product which is molded through a dual injection molding using the reinforcement member depicted in FIG. 1 according to the related art. FIG. 3 is a partial cross-sectional view taken along a line indicated by arrow A of the injection-molded product depicted in FIG. 2 according to the related art. FIG. 4 is a cross-sectional view illustrating a part of a modification of the injection-molded product depicted in FIG. 2 according to the related art.

In more detail, FIGS. 1 to 4 are views for describing an injection-molded product 10 or 20 including a reinforcement member 11 or 21, in which FIGS. 1 to 3 illustrate the injection-molded product 10 provided with insert members 15 for providing fastening means which are disposed separately from the reinforcement member 11, and FIG. 4 illustrates the injection-molded product 20 in which the reinforcement member 21 itself is provided with fastening means without disposing a separate insert member 15.

Referring to FIGS. 1 to 3, the insert member 15 of the injection-molded product 10 provides means to couple the injection-molded product 10 with a counterpart element, for example, a circuit board of a portable terminal, or to couple the injection-molded product 10 with another injection-molded product that is configured to be oppositely assembled to the injection-molded product 10 so as to complete a practical case for the portable terminal The injection-molded product 10 is completed as an injection-molded member 13 is molded in a state where the injection-molded member 13 encloses a surface of the reinforcement member 11, usually the outer surface of the reinforcement member 11. The insert members 15 are formed with screw-threads on the inner peripheral surfaces thereof, and accommodated in openings 19 formed in the reinforcement member 11, respectively. The insert members 15 are respectively arranged in the openings 19 in such a manner that a predetermined gap can be retained between the outer peripheral surface of each of the insert members 15 and the inner peripheral surface of each of the openings 19. As a molten synthetic resin is introduced into and solidified in the gaps between the outer peripheral surfaces of the insert members 15 and the inner peripheral surfaces of the openings 19, the insert members 15 can be rigidly fixed to the injection-molded member 13

However, in the process of solidifying the synthetic resin introduced around the insert members 15 in order to fix the insert members 15, a poor molding is caused due to contraction or the like at a portion with a different thickness, for example, at the synthetic resin portions introduced around the insert members 15 depicted in FIG. 3, which is a partial cross-sectional view taken along the line indicated by arrow A of FIG. 2. Such a poor molding is frequently caused when a through-hole is formed in a reinforcement member in order to mount another element, for example, an embedded antenna.

In order to address such a poor molding problem, it has been proposed to provide fastening means by processing a fastening member 25 having a screw-hole 27 on a side of the reinforcement member 21 as illustrated in FIG. 4 in order to make the thickness of the injection-molded product 23 in the outside of the reinforcement member 21 uniform. However, the fastening member 25 protrudes from the inner surface of the reinforcement member 21 by about 1.6 mm, which presents an obstacle in reducing the thickness of the injection-molded product 20 and consequently the thickness of the portable terminal.

Therefore, a need exists for an injection-molded product which secures a structural strength and impact resistance by being molded in such a manner that the injection-molded product includes a reinforcement member while suppressing a poor molding.

The above information is presented as background information only to assist with an understanding of the present disclosure. No determination has been made, and no assertion is made, as to whether any of the above might be applicable as prior art with regard to the present invention.

### SUMMARY OF THE INVENTION

Aspects of the present invention are to address at least the above-mentioned problems and/or disadvantages and to provide at least the advantages described below.

Accordingly, an aspect of the present invention is to provide an injection-molded product which secures a structural strength and impact resistance by being molded in such a manner that the injection-molded product includes a reinforcement member while suppressing a poor molding, and a mold for fabricating the same.

Another aspect of the present invention is to provide an injection-molded product having a thickness that may be easily reduced and that is strong by being provided with a reinforcement member and fastening means, and a mold for fabricating the same.

Still another aspect of the present invention is to provide an injection-molded product configured such that hardware, such as an embedded antenna, can be arranged therein, and a mold for fabricating the same.

In accordance with an aspect of the present invention, an injection-molded product is provided. The injection-molded product includes a reinforcement member formed with a through-hole, a heat-resistant member attached to an outer surface of the reinforcement member to close an opening of the through-hole, and an injection-molded member comprising a synthetic resin that encloses the outer surface of the reinforcement member.

In accordance with another aspect of the present invention, a mold configured to fabricate an injection-molded product with the above-mentioned configuration is provided. The mold includes a first mold part in which the reinforcement member is mounted, and a second mold part configured to be mated in shape with the first mold part in a state where the second mold is opposed to the outer surface of the reinforcement member. The first mold part includes a support stud protruding from an inner surface of the first mold part to be positioned in the through-hole, and the support stud supports the heat-resistant member.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a top plan view illustrating a reinforcement member used for molding a case for a portable terminal according to the related art;

FIG. 2 is a perspective view illustrating an injection-molded product which is molded through a dual injection molding using the reinforcement member depicted in FIG. 1 according to the related art;

FIG. 3 is a partial cross-sectional view taken along a line indicated by arrow A of the injection-molded product depicted in FIG. 2 according to the related art;

FIG. 4 is a cross-sectional view illustrating a part of a modification of the injection-molded product depicted in FIG. 2 according to the related art;

FIG. 5 is a top plan view illustrating a reinforcement member for an injection-molded product according to an exemplary embodiment of the present invention;

FIG. 6 is a perspective view illustrating an aspect in which heat resist members are coupled to the reinforcement member depicted in FIG. 5 according to an exemplary embodiment of the present invention;

FIG. 7 is a perspective view illustrating a part of an injection-molded product according to an exemplary embodiment of the present invention;

FIG. 8 is a partial cross-sectional view taken along a line indicated by arrow B of the injection-molded product depicted in FIG. 7 according to an exemplary embodiment of the present invention;

FIG. 9 is a schematic cross-sectional view illustrating an injection-molded product according to an exemplary embodiment of the present invention;

FIG. 10 is a schematic view illustrating a mold for fabricating the injection-molded product depicted in FIG. 5 according to an exemplary embodiment of the present invention;

FIG. 11 is a view for describing a reinforcement member while being introduced into the mold depicted in FIG. 10 according to an exemplary embodiment of the present invention; and

FIG. 12 is a schematic cross-sectional view illustrating the reinforcement member after having been introduced into the mold depicted in FIG. 10 according to an exemplary embodiment of the present invention.

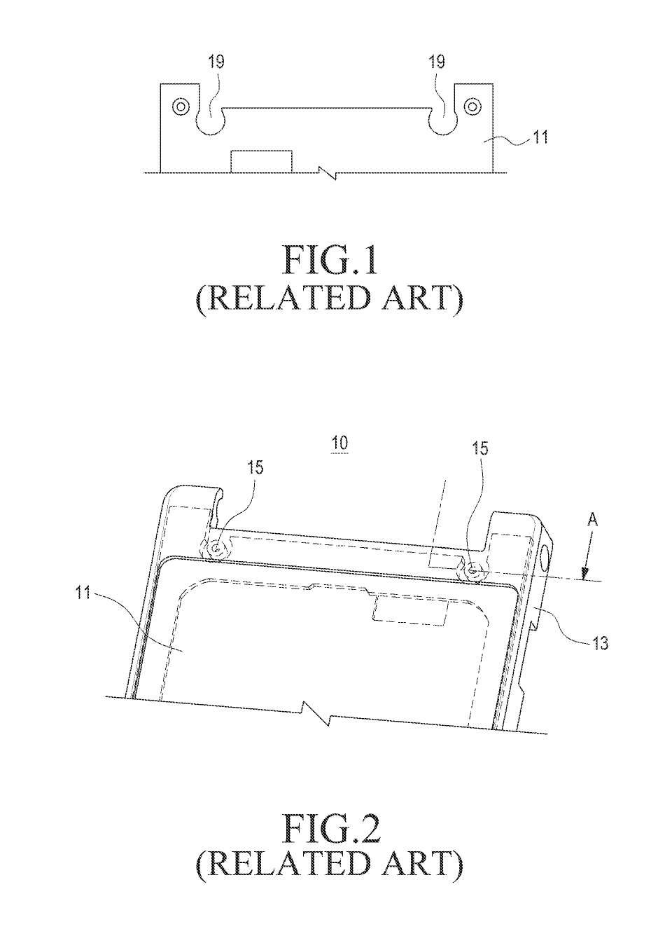

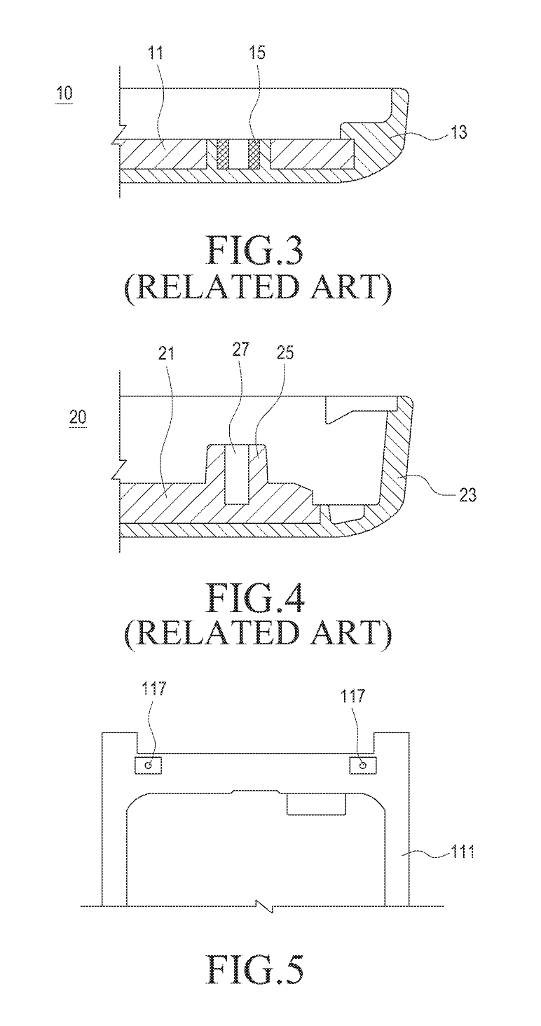

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

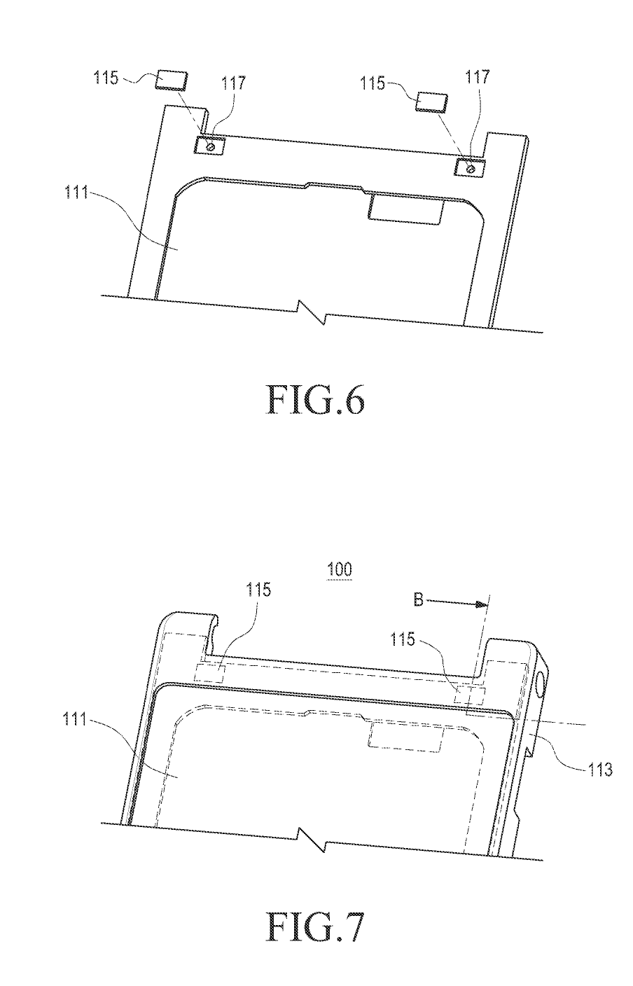

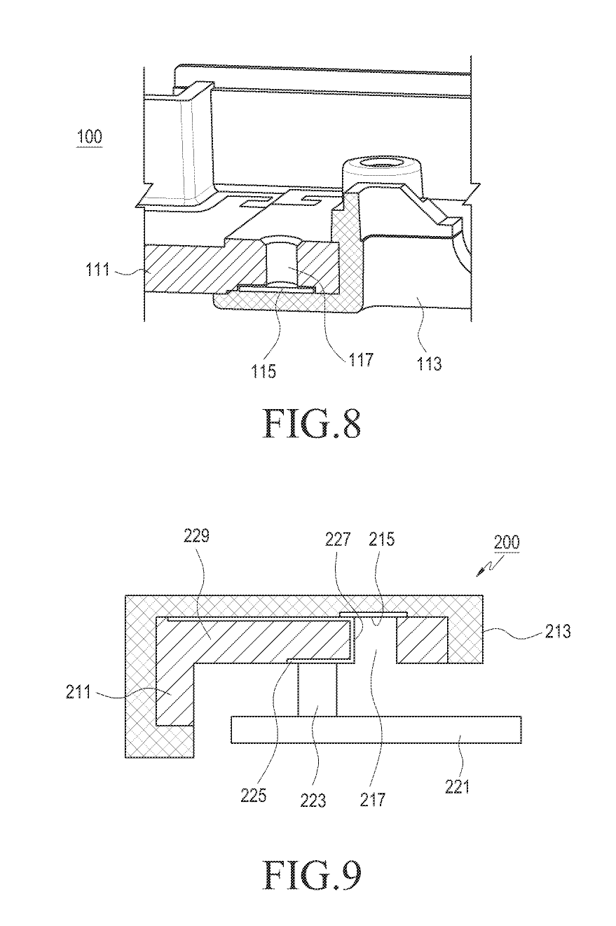

FIG. 5 is a top plan view illustrating a reinforcement member for an injection-molded product according to an exemplary embodiment of the present invention. FIG. 6 is a perspective view illustrating an aspect in which heat resist members are coupled to the reinforcement member depicted in FIG. 5 according to an exemplary embodiment of the present invention. FIG. 7 is a perspective view illustrating a part of an injection-molded product according to an exemplary embodiment of the present invention. FIG. 8 is a partial cross-sectional view taken along a line indicated by arrow B of the injection-molded product depicted in FIG. 7 according to an exemplary embodiment of the present invention.

Referring to FIGS. 5 to 8, an injection-molded product 100 includes a reinforcement member 111, an injection-molded member 113 and a heat-resistant member 115. In an exemplary implementation, the reinforcement member 111 is fabricated by processing a metal plate and the injection-molded member 113 is molded to enclose at least one surface of the reinforcement member 111, preferably the outer surface of the reinforcement member 111. Even after the injection-molded member 113 has been completely molded, the reinforcement member 111 may be partially exposed to the outside.

In an exemplary implementation, the reinforcement member 111 is a plate formed from a metallic material, for example, magnesium, and is configured to reinforce the structural strength of the injection-molded product 100 within the injection-molded product 100. In the illustrated exemplary embodiment, the injection-molded member 113 is molded to enclose the outer surface of the reinforcement member 111, in which the injection-molded member 113 will practically form the external appearance of the injection-molded product 100. The reinforcement member 111 includes at least one through-hole 117, and may include plural through-holes 117. The through-holes 117 may be formed with threads on the inner peripheral surfaces thereof to provide fastening means. In addition, as will be described below, each of the through-holes 117 may provide a surface for forming a printed circuit pattern with the inner peripheral surface thereof as illustrated in FIG. 9.

The reinforcement member 111 is introduced into the mold prior to molding the injection-molded member 113. As the molten resin introduced into the mold is solidified, the injection-molded member 113 and consequently, the injection-molded product 100 are completed in the state where one side of the reinforcement member 111, for example the outer surface of the reinforcement member 111, is enclosed by the resin. In such a case, it is preferable that the injection-molded member 113 is molded to at least partly enclose the inner surface of the reinforcement member 111 as well, so that the injection-molded member 113 is formed integrally with the reinforcement member 111.

In order to prevent the molten resin from being infiltrated into the through-holes 117 in the process of injection molding, the injection-molded product 100 is provided with the heat-resistant members 115. The heat-resistant members 115 are attached to the outer surface of the reinforcement member 111 to close the through-holes 117, respectively. As such, the heat-resistant members 115 block the infiltration of the molten resin through the through-holes 117 in the process of injection molding. In an exemplary implementation, the heat-resistant members 115 may include a metal plate formed from a stainless steel or a heat-resistant tape. In a case where the heat-resistant members 115 are formed from the metal plate, a double-sided tape (not illustrated) is attached around each of the through-holes 117 on the outer surface of the reinforcement member 111. In that state, the heat-resistant members 115 are attached to the reinforcement member 111 through the double-sided tape. In a case where the heat-resistant members 115 are formed from the heat-resistant tape, the heat-resist members 115 themselves are attached to the outer surface of the reinforcement member 111 without needing to use a separate double-sided tape.

As such, even if the through-holes 117 are formed in the reinforcement member 111 when molding the injection-molded product 100 having the reinforcement member 111, it is possible to block the infiltration of the molten resin into the through-holes 117. Accordingly, a poor external appearance can be prevented during the process of solidifying the injection-molded product 100. Furthermore, with the inventive injection-molded product 100 that blocks the infiltration of molten resin by attaching the heat-resistant members 115 to the reinforcement member 111 formed with the through-holes 117, it is possible to reduce the thickness by 0.4 mm or more as compared to the injection-molded product 10 provided with the reinforcement member 11 that forms fastening members according to the related art as illustrated in FIG. 4.

FIG. 9 is a schematic cross-sectional view illustrating an injection-molded product according to an exemplary embodiment of the present invention.

Referring to FIG. 9, a reinforcement member 211 is used as a part of an antenna device of an injection-molded product 200 including an injection-molded member 213. The reinforcement member 211 is formed with a radiation section pattern 229 on the outer surface thereof, and a contact section pattern 225 on the inner surface thereof, in which the radiation section pattern 229 is electrically connected with the contact section pattern 225 through the through-hole 217. This is enabled by using the through-hole 217 as a via hole or by forming a connection section pattern 227 on the inner wall of the through-hole 217, and connecting the opposite ends of the connection section pattern 227 to the radiation section pattern 229 and the contact section pattern 225, respectively. The reinforcement member 211 may include patterns that form a radiator, as described above, in which case it is preferable that the reinforcement member 211 is insulated from the patterns of the radiator, and may be fabricated using a dielectric material so as to implement an efficient antenna radiator. Alternatively, in order to implement an efficient antenna radiator, a dielectric material may be located between the radiation section pattern and the outer surface of the reinforcement member. However, it is natural that the reinforcement member 211 be fabricated from a material having a sufficient strength for structurally reinforcing the injection-molded product 200.

In a case where the radiation section pattern 229 and the contact section pattern 225 are formed as described above, the injection-molded product 200 is capable of accommodating a circuit board 221 of a portable terminal The circuit board 221 is provided so as to implement a control function and a communication function of the portable terminal, in which the circuit board 221 is provided with a contact member 223, for example, a C-clip on one side thereof that is capable of being connected with the contact section pattern 225. Therefore, the injection-molded product 200 may provide a means for installing the antenna device while being used as a case of the portable terminal In such a case, it is preferable that the through-hole 217 is closed by the heat-resistant member 215 on the outer surface of the reinforcement member 211.

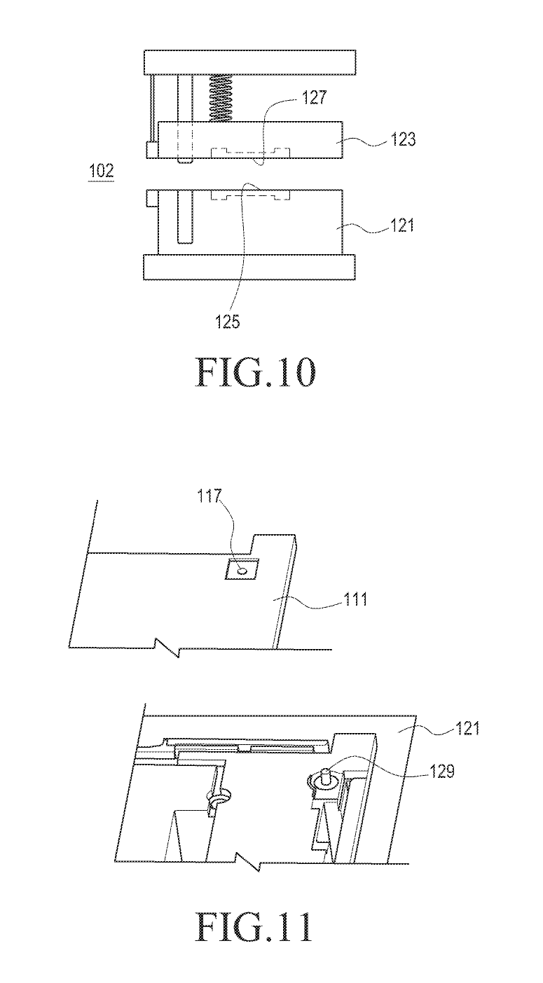

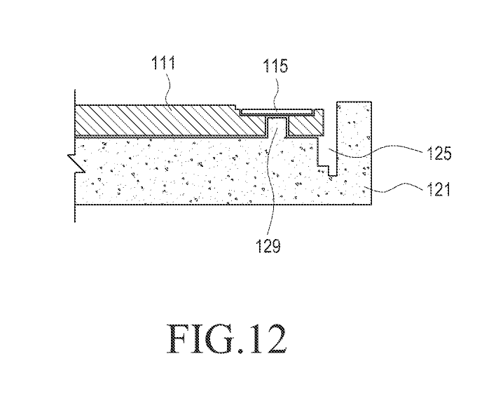

FIG. 10 is a schematic view illustrating a mold for fabricating the injection-molded product depicted in FIG. 5 according to an exemplary embodiment of the present invention. FIG. 11 is a view for describing a reinforcement member while being introduced into the mold depicted in FIG. 10 according to an exemplary embodiment of the present invention. FIG. 12 is a schematic cross-sectional view illustrating the reinforcement member after having been introduced into the mold depicted in FIG. 10 according to an exemplary embodiment of the present invention.

Referring to FIGS. 10 to 12, a mold 102 includes a first mold part 121, and a second mold part 123 that is oppositely mated in shape with the first mold part 121. The first and second mold parts 121 and 123 include molding cavities 125 and 127, respectively, and a molten resin is introduced into the molding cavities 125 and 127 in a state where the first and second mold parts 121 and 123 are mated in shape with each other in such a manner that the molding cavities 125 and 127 are opposed to each other, thereby molding the injection-molded member 113 or 213. In that event, the reinforcement member 111 or 211 is arranged in the first mold part 121 before the first and second mold parts 121 and 123 are mated in shape with each other.

The first mold part 121 is formed with a support stud 129 on a face opposed to the inner surface of the reinforcement member 111 or 211. When the reinforcement member 111 or 211 is arranged in the first mold part 121, the support stud 129 is positioned within the through-hole 117 or 217 to support the heat-resistant member 115 or 215 by its end. The heat-resistant member 115 or 215 may be deformed into the inside of the through-hole 117 or 217 by the pressure of the molten resin in the process of introducing the molten resin into the molding cavities 125 and 127 of the mold 102. However, as the support stud 129 is formed in the first mold part 121, the deformation of the heat-resistant member 115 or 215 can be prevented.

In forming the support stud 129, it is preferable that the diameter of the support stud 129 is smaller than the inner diameter of the through-hole 117 or 217. This is to ensure that the injection-molded product 100 or 200 can be easily released from the mold 102 after the injection-molded product 100 or 200 is completely molded. In an exemplary implementation, the support stud 129 has a diameter smaller than the inner diameter of the through-hole 117 by about 0.03 mm. By being formed having this diameter, the support stud 129 prevents the deformation of the heat-resistant member 115 and 215 and allows the injection-molded product 100 or 200 to be easily released from the mold 102 after the injection-molded product 100 or 200 is completed.

An exemplary injection-molded product as described above allows the thickness thereof to be reduced by about 0.4 mm as compared to the injection-molded product of the related art while securing the same structural strength and impact resistance. Accordingly, the inventive injection-molded product is capable of contributing to reducing a size, especially a thickness of a portable electronic device, such as a portable terminal. In addition, because the infiltration of a molten resin into the through-holes of the reinforcement member is prevented by arranging the heat-resistant members to close the through-holes, it is possible to prevent a poor molding, such as contraction, from having an impact on the external appearance. Furthermore, because constitutional elements of an antenna, such as a radiation section pattern, can be arranged using the reinforcement member, the internal space of the case of the portable electronic device can be efficiently used. Moreover, because it is not necessary to provide a separate fastening means, such as an insert member, there is an advantage in that it is possible to simplify a manufacturing process, and hence to reduce manufacturing costs.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. An injection-molded product comprising:
a reinforcement member formed with a through-hole;
a heat-resistant member attached to an outer surface of the reinforcement member to close an opening of the through-hole; and
an injection-molded member comprising a synthetic resin that encloses the outer surface of the reinforcement member.

2. The injection-molded product of claim 1, wherein the reinforcement member comprises a metal plate.

3. The injection-molded product of claim 1, wherein the through-hole comprises screw threads on an inner wall thereof

4. The injection-molded product of claim 1, wherein the heat-resistant member comprises a metal plate formed from a stainless steel.

5. The injection-molded product of claim 4, wherein the heat-resistant member is attached to an outer surface of the reinforcement member by a double-sided tape so as to close the opening of the through-hole.

6. The injection-molded product of claim 1, wherein the heat-resistant member comprises a heat-resistant tape.

7. The injection-molded product of claim 1, wherein the reinforcement member comprises magnesium.

8. The injection-molded product of claim 1, further comprising:
a radiation section pattern formed on the outer surface of the reinforcement member; and
a contact section pattern formed on an inner surface of the reinforcement member and configured to be electrically connected with the radiation section pattern through the through-hole.

9. The injection-molded product of claim 8, wherein the injection-molded product is configured to accommodate a circuit board arranged to be opposed to the inner surface of reinforcement member, and to electrically connect the contact section pattern to the circuit board.

10. The injection-molded product of claim 8, further comprising:
a connection section pattern formed on an inner wall of the through-hole, wherein opposite ends of the connection section pattern are connected with the radiation section pattern and the contact section pattern, respectively.

11. The injection-molded product of claim 8, further comprising:
a dielectric material located between the radiation section pattern and the outer surface of the reinforcement member.

12. A mold configured to manufacture an injection-molded product which comprises a metallic reinforcement member formed with a through-hole, a heat-resistant member attached to an outer surface of the reinforcement member to close an opening of the through-hole, and an injection-molded member comprising a synthetic resin that encloses the outer surface of the reinforcement member, the mold comprising:
a first mold part in which the reinforcement member is mounted; and
a second mold part configured to be mated in shape with the first mold part in a state where the second mold is opposed to the outer surface of the reinforcement member,
wherein the first mold part comprises a support stud protruding from an inner surface of the first mold part to be positioned in the through-hole, and wherein the support stud supports the heat-resistant member.

13. The mold of claim 12, wherein the support stud has a diameter smaller than an inner diameter of the through-hole.

14. The mold of claim 12, wherein the support stud has a diameter smaller than an inner diameter of the through-hole by about 0.03 mm.

15. The mold of claim 12, wherein the first and second mold parts are mated in shape with each other in a state where the reinforcement member is mounted in the first mold part, thereby defining a molding cavity, and a molten resin is introduced into the molding cavity so that the injection-molded member is molded.
